(19) United States
(12) Patent Application Publication
(10) Pub. No.: US 2010/0323154 A1
(43) Pub. Date: Dec. 23, 2010

(54) Multifunction Cushion Apparatus for Wristwatches and Wristwatch Bands and Methods Thereof

(76) Inventor: Michael Sharobiem, Torrance, CA (US)

Correspondence Address: EDWARD C. SCHEWE, 1600 Rosecrans Avenue, Fourth Floor, MANHATTAN BEACH, CA, 90266, US

(21) Appl. No.: 12/490,142

(22) Filed: Jun. 23, 2009

(51) Int. Cl. B32B 3/10; B32B 3/26; B32B 7/12; B05D 5/10

(52) U.S. Cl. 428/131; 428/221; 428/220; 428/317.3; 427/207.1; 368/281

(57) ABSTRACT

An improved multifunction cushion apparatus for wristwatches and associated bands used by the individual watch wearer by attaching the inventive pad to the back of the wristwatch casing and to the back of the wristwatch band. A pad or a pad and associated cross members are utilized to increase comfort, decrease rubbing and irritation, provide moisture control and provide antimicrobial properties when wearing a wristwatch and band without impacting the visual appeal and style of the wristwatch and its band.

### BACKGROUND OF THE INVENTION

1. Field of the Invention

This present invention is directed to cushion apparatus for wristwatches and the associated bands that fasten the watch about a person's wrist and more particularly, to cushioning pads that improve comfort and wearability of wristwatches without detracting from a wristwatch's visual appeal.

2. Description of the Related Art

Individuals have worn wristwatches for many years to quickly be able to tell the time and date but also as a fashion statement and to enhance their appearance. Many individuals have numerous wristwatches in different shapes and sizes. The watch bands that secure the watch about the wearer's wrist also come in different sizes and are made from different types of materials.

After wearing various types of wristwatches including designer brands and “no name” watches, one often realizes how discomforting a wristwatch can be. After a day of suffering with discomfort from the weight and shapes of a few watches, one can often notice swelling and bruising on his or her wrist.

Materials used for wristwatch bands can cause sweating and even snag the tiny hairs on sensitive areas of a person's skin in addition to constant rubbing that causes irritation. A person can spend large sums of money on a wristwatch and a stylish band only to discover later that both are extremely uncomfortable to wear for long periods of time. A need exists for an improved multifunctional apparatus that address the issue of comfort, rubbing and irritation when wearing a wristwatch and band without sacrificing the visual appeal and style that people have come to expect from their wristwatches.

### SUMMARY OF THE INVENTION

The invention provides a one stop solution to the conflicting problems of wristwatch style, utility and comfort. The present invention provides improved comfort and utility to a person wearing a stylish wristwatch and band but does not detract from the wristwatch's desirable visual appeal because while in use the apparatus is virtually undetectable to casual observers.

In a first embodiment, a cushion apparatus in the form of a pad is provided that is adapted to substantially conform to the back of a wristwatch casing. The pad is substantially made from cellular foam having antimicrobial properties that inhibits growth of microorganisms that occur between the wristwatch and the skin of the person wearing the wristwatch and controls moisture by absorbing moisture from the person's skin. The pad can be made from multicellular urethane foam adapted to inhibit growth of fungus or bacteria and can also be adapted to provide enhanced moisture control to wick moisture away from the person's skin.

In alternatives, the pad has a thickness of approximately 2 to 3 millimeters and an adhesive is applied to secure the pad onto the wristwatch casing. The pad can be configured in different shapes and sizes and can have an aperture of variable depth into the pad. The pad is a spacer between the wristwatch casing and the wrist of the person wearing the wristwatch.

In other embodiments, a cushion apparatus for a wristwatch band is provided that includes a pad and a plurality of cross members. The pad and the attached cross members are attached to the underside of the wristwatch: band to provide a cushion between the band and the skin of the person wearing the band. The pad and the cross members can be substantially made from cellular foam with antimicrobial properties that inhibits growth of microorganisms that occur between the wristwatch band and the skin of the person wearing the wristwatch band and to absorb moisture from the person's skin. The pad and the cross members can be substantially made from multicellular urethane foam adapted to inhibit growth of fungus or bacteria, and can also be adapted to provide enhanced moisture control to wick moisture away from the person's skin.

In alternatives, the pad or the cross members have a thickness of approximately 2 to 3 millimeters and an adhesive can be used secure the pad or the cross members to the wristwatch band. The combination of the pad and the cross members for the wristwatch band comprise a spacer between the band and the portions of the skin of the person wearing the wristwatch band in contact with the pad and the cross members.

A further embodiment contemplates methods for adding cushioning to a wristwatch and its associated band by making a first pad for the wristwatch and a second pad and cross members for the wristwatch band. Both pads and cross members are substantially made from multicellular urethane foam adapted to inhibit growth of fungus or bacteria and can also adapted to provide enhanced moisture control to wick moisture away from the person's skin. Additional methods include the step of cutting the length of the second pad to a desired length to accommodate different band lengths, the step of making the cross members in different sizes to accommodate different widths of the wristwatch band and the step of distributing-two or more of the assembled second pads and plurality of different size cross members in a package.

Further advantages and embodiments of the invention will be apparent to persons skilled in the art from the drawings and description set forth herein.

### BRIEF DESCRIPTION OF THE DRAWINGS

FIGS. 1A-1D are perspective views of embodiments of the invention shoving different sizes of cushion apparatus for the invention.

FIG. 2 is a perspective view of an embodiment of a cushion apparatus for the invention.

FIG. 3 is a perspective view of an embodiment of invention showing a cushion apparatus for the wristwatch casing.

FIGS. 4A-4C are perspective views of embodiments of the invention showing different sizes of cushion apparatus for wristwatch bands.

FIG. 5 is a perspective view of an embodiment of the invention illustrating a cushion apparatus for a wristwatch band.

### DETAILED DESCRIPTION OF THE INVENTION

Reference is made to the Figures in which elements of the illustrated embodiments of the invention are given numerical designations so as to enable one skilled in the art to make and use the invention. It is understood that the following description is exemplary of embodiments of the invention and it is apparent to skilled persons that modifications are possible without departing from the inventive concepts herein described.

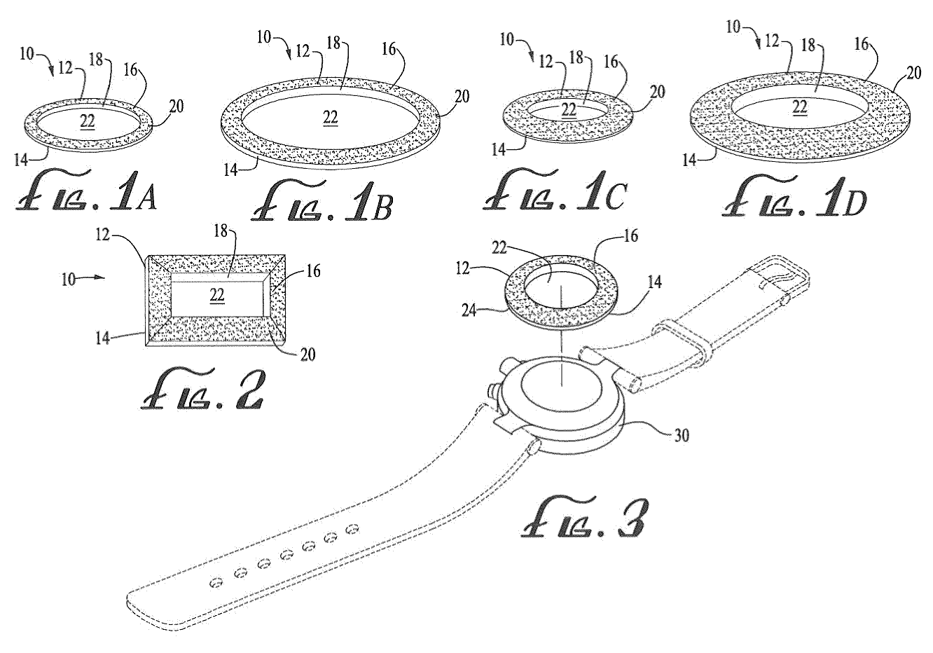

As shown in FIGS. 1A-1D, in embodiments of the invention the apparatus 10 includes the pad 12. The pad 12 has the first surface 14 and the second surface 16 and a thickness 18 between the first surface 14 and the second surface 16. The pad 12 includes the rounded edge 20 adjacent to the second surface 16.

In the embodiments shown in FIGS. 1A-1D, the pad 12 includes the aperture 22 that is a feature that can minimize the amount of material used to manufacture the pad 12. The aperture 22 can extend through the pad 12 from the second surface 16 to the first surface 14 and in further embodiments the aperture 22 extends only partially into the pad 12. The diameter of the aperture 22 can vary also as shown in FIGS. 1A-1D.

The pad 12 is made from materials known to persons skilled in the art to provide a smooth cushioning surface to lessen irritation of a person's skin when the materials contact the person's skin and for moisture control meaning to absorb moisture from the person's skin. Materials that have antimicrobial properties are those that kill, inhibit or provide resistance to growth of microorganisms such as bacteria and fungus. Materials for use with embodiments of the invention include PORON®, PORON® PERMAFRESH® and PORON® ProZorb™ microcellular urethane foams from Rogers Corporation of Woodstock, Conn. that provide antimicrobial protection and inhibit or provide resistance to growth of fungus or bacteria and for moisture control. PORON® ProZorb™ also provides enhanced moisture control to wick moisture away from a person's skin to keep the skin dry and comfortable.

The pad 12 can be in different sizes to accommodate different wristwatch sizes and in particular the size of the wristwatch casing. FIG 1A illustrates an embodiment for a small size wristwatch casing and FIG. 1B illustrates an embodiment for a larger size wristwatch casing such as may be found with some men's wristwatches. FIG. 1C illustrates an embodiment for a medium size wristwatch casing and FIG. 1D shows an embodiment for a larger wristwatch casing with a smaller diameter aperture 22. In embodiments of the invention, the pad 12 can be distributed in a package of such pads 12 in different sizes and shapes to accommodate a number of different wristwatches that a person might have.

FIG. 2 illustrates an embodiment where the pad 12 is in a different shape such as a rectangular cross-sectional shape. The pad 12 can be made to fit onto wristwatches of many shapes and configurations including but not limited to, circular, rectangular, triangular and oval, all of which are within the scope of the present invention.

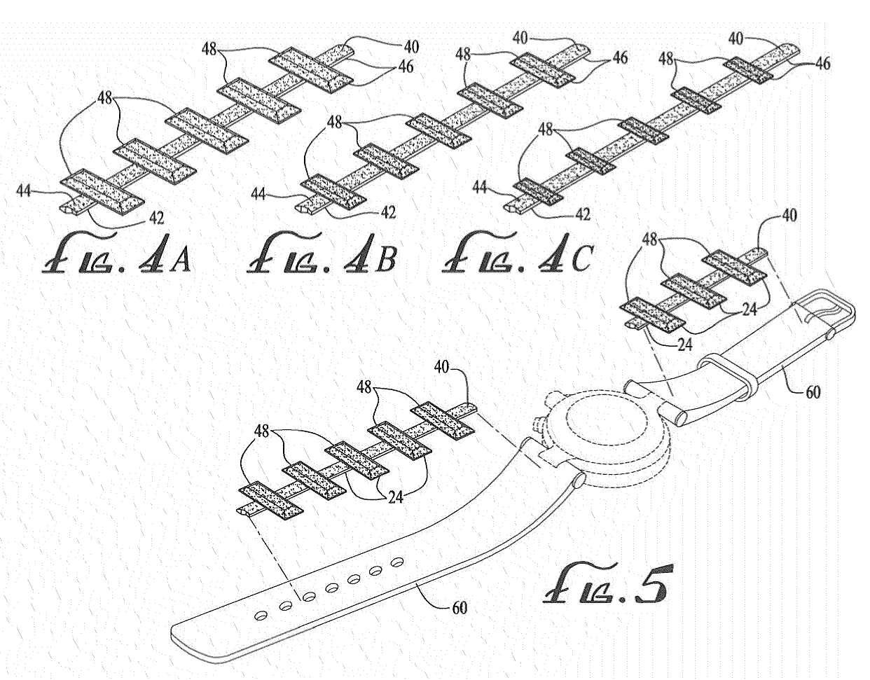

FIG. 3 illustrates placement of the pad 12.onto the back of a wristwatch casing 30. The pad 12 does not extend outside of the edges of the wristwatch casing 30 in FIG. 3 so as to not detract from the visual appeal of the wristwatch while it is being worn. Adhesive is used to hold the pad 12 onto the wristwatch casing 30 and the invention includes adhesives well known to persons skilled in the art.

In embodiments, the pad 12 has a pressure sensitive adhesive layer 24 applied to the first surface 14. The pressure sensitive adhesive layer 24 is exposed by a person peeling away a backing off of the adhesive layer 24 and then applying the first surface 14 onto the wristwatch casing 30 to cause the pad 12 to be adhered to the wristwatch casing 30. The pad 12 is removable from the wristwatch casing 30. The pad 12 applied to the watch casing 30 as described and shown in FIG. 3 is a spacer that separates the wristwatch casing 30 from the skin of the person wearing the wristwatch so the watch is more comfortable to wear and to minimize rubbing between the wristwatch and the person's skin and lessening the irritation caused by such rubbing. In the embodiments shown in FIG. 3, the aperture 22 extends through the pad 12 from the first surface 14 to the second surface 16.

FIGS. 4A-4C illustrate embodiments of the invention for a wristwatch band. The term band includes the commonly used straps used to buckle or fasten a timepiece to a person's arm or wrist. The pad 40 is elongated and has a first surface 42 and a second surface 44 with a rounded edge 46 as illustrated in FIGS. 4A-4C. A number of cross members 48 are secured to the pad 40. The cross members 48 can be arranged transverse to the pad 40 as shown in FIGS. 4A-4C or at any angular orientation with respect to the pad 40 to provide a cushion and other desirable features for a particular wristwatch wearer. The number of cross members 48 secured to the pad 40 can be one or more and all of these alternative embodiments are within the scope of the invention. The cross members 48 can also have a rounded edge 46 as shown in FIGS. 4A-4C.

The length of the pad 40 can be adjusted to accommodate different lengths of the wristwatch band. For example, the pad 40 can be cut to a desired length. The cross members 48 can be in different lengths to accommodate different wristwatch band sizes. FIG. 4A illustrates an embodiment for a wide size wristwatch band, FIG. 4B illustrates an embodiment for a somewhat narrower wristwatch band and FIG. 4C illustrates an embodiment for a small width wristwatch band. The present invention is not limited to any size, length or shape of the cross members 48 and all sizes and shapes that can accommodate the wristwatch bands are within the scope of the invention.

In embodiments of the invention, the pad 40 and a plurality of cross members 48 can be preassembled in different sizes such as illustrated in FIGS. 4A-C and sold in a package. For example, a package of preassembled pad 40 and cross member 48 combinations can include an embodiment for a small size wristwatch band, an embodiment for a medium size wristwatch band, an embodiment for a wide size wristwatch band and other sizes.

The pad 40 and the cross members 48 are made from materials known to persons skilled in the art to provide a smooth cushioning surface to lessen irritation of a person's skin when the materials contact the person's skin and for moisture control meaning to absorb moisture from the person's skin. As described above, materials for use with embodiments of the invention include PORON®, PORON®. PERMAFRESH® and PORON® ProZorb™ microcellular urethane foams from Rogers Corporation of Woodstock, Conn. that provide antimicrobial protection, inhibit or provide resistance to growth of fungus or bacteria, provide moisture control and for PORON® ProZorb™, also provides enhanced moisture control to wick moisture away from a person's skin to keep the skin dry and comfortable.

FIG. 5 illustrates placement of the pad 40 and cross members 48 onto the bottom of a wristwatch band 60. As can be appreciated from FIG. 5, the pad 40 and cross members 48 do not extend outside of the edges of the wristwatch band 60 so as to not detract from the visual appeal of the wristwatch and the band 60 While they are being worn.

Adhesive is used to hold the pad 40 and cross members 48 onto the wristwatch band 60 which adhesives are known to persons skilled in the art. In embodiments of the invention, one or both of the pad 40 and the cross members 48 includes a layer of pressure sensitive adhesive 24 applied to first surface 42 of the pad 40 or the bottom surfaces of the cross members 48 which is exposed by peeling away a backing off of the adhesive layer by a user and then applying either the first surface 42 or the bottom surfaces of the cross members 48 onto the bottom portion of the wristwatch band 30.

The pad 40 and the cross members 48 are removable from the wristwatch band 60. The pad 40 and the cross members 48 applied to the watchband 60 as described and shown in connection with FIG. 5 are a spacer that separates the wristwatch band from the skin of the person wearing the band so the band is more comfortable to wear and to minimize rubbing between the band and the person's skin and lessening the irritation caused by such rubbing.

While the present invention has been described with regards to particular embodiments, it is recognized that additional variations of the present invention may be devised by persons skilled in the art without departing from the inventive concepts disclosed herein and the invention is entitled to the full breadth and scope of the claims.

What is claimed is:

1. A cushion apparatus for a wristwatch adapted to be worn about a person's wrist comprising:
a pad adapted to substantially conform to the planar shape of a wristwatch casing, the pad having a first surface and a second surface;
the first surface adapted to be secured onto the back portion of the wristwatch casing, the first surface and the second surface configured so that when the first surface is secured to the back portion of the wristwatch casing the second surface is positioned to contact a portion of the skin of the person wearing the wristwatch; and
the pad substantially made from cellular foam having antimicrobial properties such that the pad inhibits growth of microorganisms associated with the portion of the skin of the person wearing the wristwatch that is in contact with the pad.

2. The apparatus of claim 1 wherein the foam is multicellular urethane foam adapted to inhibit growth of fungus or bacteria and to absorb moisture from the portion of the skin of the person wearing the wristwatch that is in contact with the pad.

3. The apparatus of claim 1 wherein the pad has a thickness of approximately in the range of 2 to 3 millimeters.

4. The apparatus of claim 1 further comprising adhesive applied to the first surface of the pad to secure the first surface to the wristwatch casing.

5. The apparatus of claim 1 wherein the pad has a substantially cylindrical shape.

6. The apparatus of claim 1 wherein the pad has a substantially rectangular cross sectional shape.

7. The apparatus of claim 1 wherein the pad includes an aperture that extends below the second surface.

8. The apparatus of claim 1 wherein the pad comprises a spacer between the wristwatch casing and the wrist of the person wearing the wristwatch.

9. A cushion apparatus for a wristwatch band, the wristwatch band having a top, a bottom, a length and a width and adapted to be attached to a wristwatch and adapted to be fastened about the wrist of a person, comprising:
a pad having a first surface and a second surface, the first surface adapted to be secured to the bottom of the wristwatch band along a portion of the length and a portion of the width of the wristwatch band, the first surface and the second surface configured so that when the first surface is secured to the bottom of the wristwatch band, the second surface is substantially positioned to contact a portion of the skin of the person wearing the wristwatch band;
a plurality of cross members secured to the pad, the cross members configured to extend about at least a portion of the width of the wristwatch band and to contact additional portions of the skin of the person wearing the wristwatch band; and
the pad and the cross members substantially made from cellular foam with antimicrobial properties adapted to inhibit growth of microorganisms associated with the portion of the skin of the person wearing the wristwatch band that is in contact with the pad and the cross members.

10. The apparatus of claim 9 wherein the foam is multicellular urethane foam adapted to inhibit growth of fungus or bacteria and to absorb moisture from the portion of the skin of the person wearing the wristwatch band that is in contact with the pad or the cross members.

11. The apparatus of claim 9 wherein the pad has a thickness of approximately in the range of 2 to 3 millimeters.

12. The apparatus of claim 9 wherein at least one of the cross members have a thickness of approximately in the range of 2 to 3 millimeters.

13. The apparatus of claim 9 wherein the first surface has adhesive applied thereto to secure the first surface of the pad to the wristwatch band.

14. The apparatus of claim 9 wherein the pad and the cross members comprise a spacer between the wristwatch band and the portions of the skin of the person wearing the wristwatch band in contact with the pad and the cross members.

15. A method for adding cushioning to a wristwatch adapted to be attached about the wrist of a person by a wristwatch band having a length, a width, a bottom and a top, the steps comprising:
making a first pad configured to substantially conform to the planar shape of a wristwatch casing and adapted to fit between the wristwatch casing and the wrist of the person wearing the wristwatch, the first pad made substantially of a multicellular urethane foam adapted to inhibit, growth of fungus or bacteria between the wristwatch casing and the person's wrist and to wick moisture away from the person's wrist while the wristwatch is being worn; and
applying adhesive to the first pad so that the first pad is adapted to be removably secured to the wristwatch casing.

16. The method of claim 15 further comprising the steps of:
making a second pad configured to be secured to the bottom of the wristwatch band along a portion of the length and apportion of the width of the wristwatch band and adapted to fit between the bottom of the wristwatch band and the wrist of the person wearing the wristwatch band, the second pad made of a multicellular urethane foam adapted to inhibit growth of fungus or bacteria between the wristwatch band and the person's wrist and to wick moisture away from the person's wrist while the wristwatch band is being worn;
securing a plurality of cross members to the second pad, the cross members configured to extend about a portion of the width of the wristwatch band and adapted to fit between the bottom of the wristwatch band and the wrist of the person wearing the wristwatch band, the cross members made of a multicellular urethane foam adapted to inhibit growth of fungus or bacteria between the wristwatch band and the person's wrist and to wick moisture away from the person's wrist while the wristwatch band is being worn; and
applying adhesive to at least one of the second pad and the plurality of cross members so that the second pad or the plurality of cross members is adapted to be removably secured to the wristwatch band.

17. The method of claim 16 further comprising the step of cutting the second pad to a desired length to accommodate the length of the wristwatch band.

18. The method of claim 16 further comprising the step of making the cross members in different sizes to accommodate different widths of the wristwatch band.

19. The method of claim 18 further comprising the step of distributing two or more of the assembled second pads and plurality of cross members in a package.
